(19) United States
(12) Patent Application Publication
(10) Pub. No.: US 2007/0050687 A1
(43) Pub. Date: Mar. 1, 2007

(54) Watchdog monitoring circuit and method for controlling energization of the load using the watchdog monitoring circuit

(76) Inventors: Robert J. Disser, Dayton, OH (US); Jeff A. Foust, Eaton, OH (US); Patrick A. Mescher, Bellbrook, OH (US)

Correspondence Address: DELPHI TECHNOLOGIES, INC., M/C 480-410-202, PO BOX 5052, TROY, MI, 48007, US

(21) Appl. No.: 11/204,819

(22) Filed: Aug. 16, 2005

(51) Int. Cl. G06F 11/00

(52) U.S. Cl. 714/55

(57) ABSTRACT

A watchdog monitoring circuit and a method related thereto are provided. The watchdog monitoring circuit includes a first signal detection circuit configured to determine a first error condition associated with a first device when the first signal detection circuit does not receive a first plurality of signal pulses having a first predetermined characteristic from the first device. The watchdog monitoring circuit further includes a second signal detection circuit configured to determine a second error condition associated with a second device when the second signal detection circuit does not receive a second plurality of signal pulses having a second predetermined characteristic from the second device. The watchdog monitoring circuit further includes a first electrical control circuit operably associated with the first and second signal detection circuits. The first electrical control circuit is configured to remove power from a load when either the first signal detection circuit determines the first error condition or the second signal detection circuit determines the second error condition.

### TECHNICAL FIELD

This application relates to a watchdog monitoring system and a method for controlling energization of the load using the watchdog monitoring system.

### BACKGROUND

A watchdog circuit has been developed which monitors an output signal generated by a controller. When the watchdog circuit does not receive the output signal indicating an error condition, the watchdog circuit removes power from a load. A problem associated with this watchdog circuit is that the watchdog circuit is not configured to monitor a plurality of output signals having similar or different signal characteristics generated by a plurality of devices, and to remove power from a load when at least one of the output signals are not received.

Accordingly, the inventors herein have recognized a need for an improved watchdog circuit that can monitor a plurality of output signals from a plurality of devices.

### SUMMARY

A watchdog monitoring circuit in accordance with an exemplary embodiment is provided. The watchdog monitoring circuit includes a first signal detection circuit configured to determine a first error condition associated with a first device when the first signal detection circuit does not receive a first plurality of signal pulses having a first predetermined characteristic from the first device. The watchdog monitoring circuit further includes a second signal detection circuit configured to determine a second error condition associated with a second device when the second signal detection circuit does not receive a second plurality of signal pulses having a second predetermined characteristic from the second device. The watchdog monitoring circuit further includes a first electrical control circuit operably associated with the first and second signal detection circuits. The first electrical control circuit is configured to remove power from a load when either the first signal detection circuit determines the first error condition or the second signal detection circuit determines the second error condition.

A method for controlling energization of a load utilizing a watchdog monitoring circuit electrically coupled to an electrical control circuit, in accordance with another exemplary embodiment is provided. The watchdog monitoring circuit has first and second signal detection circuits electrically coupled to the electrical control circuit. The electrical control circuit is electrically coupled to the load. The method includes determining a first error condition associated with a first device when the first signal detection circuit does not receive a first plurality of signal pulses having a first predetermined characteristic from the first device, indicating a first error condition associated with the first device. The method further includes determining a second error condition associated with a second device when the second signal detection circuit does not receive a second plurality of signal pulses having a second predetermined characteristic from the second device, indicating a second error condition associated with the second device. The method further includes removing power from the load when at least one of the first and second error conditions are determined, utilizing the electrical control circuit.

### BRIEF DESCRIPTION OF THE DRAWINGS

FIG. 1 is a schematic of a control system and having a first embodiment of a watchdog monitoring circuit and an energization circuit;

FIG. 2 is a schematic of a second embodiment of a watchdog monitoring circuit; and

FIG. 3 is a schematic of a third embodiment of a watchdog monitoring circuit.

### DESCRIPTION OF EXEMPLARY EMBODIMENTS

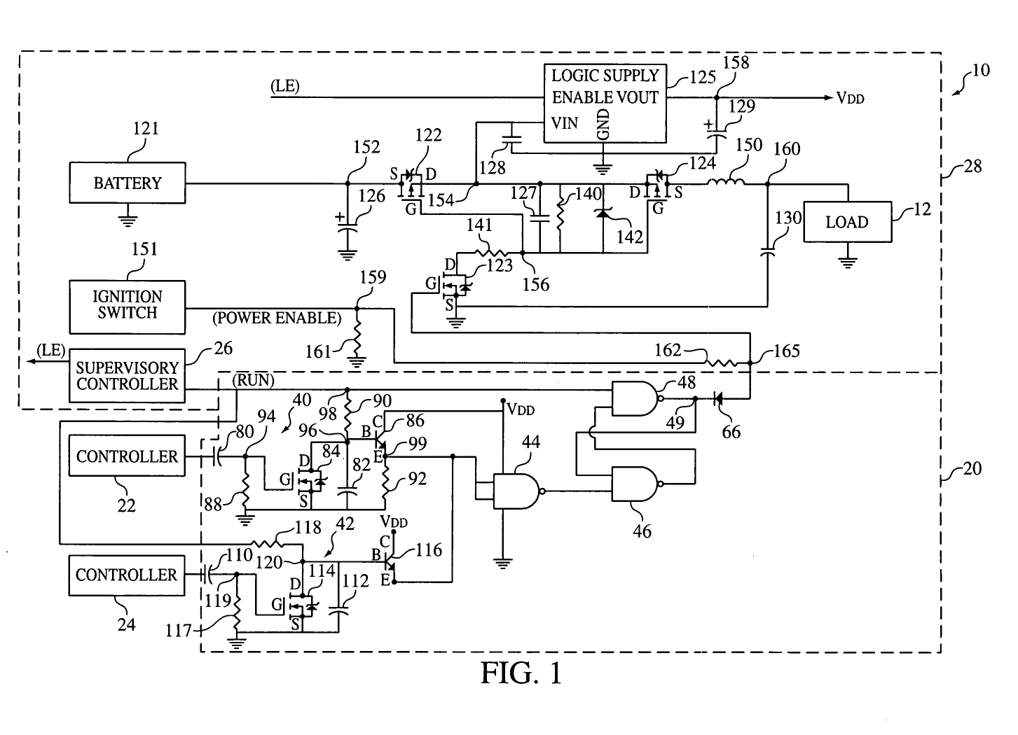

Referring to FIG. 1, a control system 10 for controlling energization of a load 12 is provided. The control system 10 includes a watchdog monitoring circuit 20, controllers 22, 24, and an energization circuit 28. Although only two controllers are utilized in this embodiment, additional controllers can be utilized in other embodiments.

The watchdog monitoring circuit 20 is provided to monitor signal pulses from the controllers 22 and 24 used for determining whether the controllers are operating as desired, and for turning off power to at least one load when an error condition is detected. During desired operation, the controller 22 outputs a first plurality of signal pulses having a predetermined characteristic, indicating a desired operation of the controller 22, which is received by the watchdog monitoring circuit 20. The first plurality of signal pulses comprise a plurality of voltage or current pulses having a predetermined frequency. For example, the first plurality of signal pulses can comprise pulse width modulated (PWM) signal pulses having a predetermined frequency. Accordingly, when the watchdog monitoring circuit 20 does not receive the first plurality of signal pulses having a predetermined characteristic from the controller 22, an operational error condition is identified.

Similarly, the controller 24 during desired operation outputs a second plurality of signal pulses having a predetermined characteristic, indicating desired operation of the controller 24, which is received by the watchdog monitoring circuit 20. The second plurality of signal pulses comprise a plurality of voltage or current pulses having a predetermined frequency. For example, the second plurality of signal pulses can comprise PWM signal pulses having a predetermined frequency. Accordingly, when the watchdog monitoring circuit 20 does not receive the second plurality of signal pulses having a predetermined characteristic from the controller 22, an operational error condition is identified.

The watchdog monitoring circuit 20 is provided to monitor operation of the controller 22 and the controller 24. The watchdog monitoring circuit 20 includes a signal detection circuit 40, a signal detection circuit 42, NAND gates 44, 46, 48, and diode 66. It should be noted that in an alternate embodiment, the watchdog monitoring circuit 20 could have a plurality of additional signal detection circuits, each like signal detection circuit 42.

The signal detection circuit 40 is provided to monitor an output signal from the controller 22 and to determine whether the controller 22 is outputting a signal having a predetermined characteristic. The signal detection circuit 40 includes capacitors 80, 82, transistors 84, 86, the resistors 88, 90, 92. The capacitor 80 is electrically coupled between the controller 22 and a node 94. The resistor 88 is electrically coupled between node 94 and electrical ground. The node 94 is electrically coupled to a gate (G) of the transistor 84. The source (S) of the transistor 84 is electrically coupled to electrical ground, and the drain (D) of the transistor 84 is electrical coupled to a node 96. The resistor 90 is electrically coupled between nodes 98, 96, and the capacitor 82 is electrically coupled between the node 96 and electrical ground. The node 96 is electrically coupled to a base (B) of the transistor 86. The collector (C) of the transistor 86 receives the voltage (V_{DD}) from the logic supply 125. The emitter (E) of the transistor 86 is electrically coupled to the node 99. The resistor 92 is electrically coupled between the node 99 and electrical ground.

The signal detection circuit 42 is provided to monitor an output signal from the controller 24 and to indicate whether the controller 24 is outputting a signal having a predetermined characteristic. The signal detection circuit 42 includes capacitors 110, 112, transistors 114, 116, and resistors 117, 118. The capacitor 110 is electrically coupled between the controller 24 and a node 119. The resistor 117 is electrically coupled between node 119 and electrical ground. The node 119 is electrically coupled to a gate (G) of the transistor 114. The source (S) of the transistor 114 is electrically coupled to electrical ground, and the drain (D) of the transistor 114 is electrical coupled to a node 120. The resistor 118 is electrically coupled between nodes 98, 120, and the capacitor 112 is electrically coupled between the node 120 and electrical ground. The node 120 is electrically coupled to a base (B) of the transistor 116. The collector (C) of the transistor 116 receives the voltage (V_{DD}) from the logic supply 125. The emitter (E) of the transistor 116 is electrically coupled to the node 99.

The NAND logic gate 44 has first and second input terminals electrically coupled to the node 99. The NAND logic gate 44 has an output terminal electrically coupled to a first input terminal of the NAND logic gate 46. The NAND logic gate 46 has a second input terminal electrically coupled to a node 49. The node 49 is electrically coupled to an output terminal of the NAND logic gate 48. The NAND logic gate 48 has a first input terminal electrically coupled to the supervisory controller 26 and a second input terminal electrically coupled to the output terminal of NAND gate 46. The diode 66 is electrically coupled between the nodes 49, 165.

During desired operation of controller 22, the controller 22 generates a first output signal having a predetermined characteristic that is received by the signal detection circuit 40. In one embodiment, the controller 22 generates a PWM signal having a predetermined frequency that is received by the signal detection circuit 40. When the transistor 84 receives the first output signal via the capacitor 80, the transistor 84 discharges the capacitor 82 below a threshold voltage level such that the node 96 has a low logic voltage. When the node 96 has a low logic voltage, the transistor 86 is turned off and the node 99 has a low logic voltage. When first and second input terminals of the NAND logic gate 44, coupled to node 99, have a low logic voltage, the NAND logic gate 44 outputs a high logic voltage that is received at a first input terminal of the NAND logic gate 46. When the first input terminal of the NAND logic gate 46 has a high logic voltage and the second input terminal of the gate 46 has a high logic voltage, the gate 46 outputs a low logic voltage that is received at the second input terminal of the NAND logic gate 48. When the NAND logic gate 48 has a high logic voltage at the first input terminal from the supervisory controller 22 and a low logic voltage at the second input terminal, the gate 48 outputs a high logic voltage that allows transistor 123 to turn on when ignition switch 151 is closed. When the transistor 123 is turned on, a supply voltage is supplied to the load 12.

During an operational error condition of the controller 22, the transistor 84 does not receive the first output signal having the predetermined characteristic from the controller 22. As a result, the transistor 84 allows the capacitor 82 to be charged greater than or equal to a threshold voltage such that the node 96 has a high logic voltage. When the node 96 has a high logic voltage, the transistor 86 is turned on and the node 99 has a high logic voltage. When the first and second input terminals of the NAND logic gate 44, coupled to the node 99, have a high logic voltage, the NAND logic gate 44 outputs a low logic voltage that is received at the first input terminal of the NAND logic gate 46. When the first input terminal of the NAND logic gate 46 has a low logic voltage from the gate 44 and the second input terminal of the gate 46 has a high logic voltage, the gate 46 outputs a high logic voltage that is received at the second input terminal of the NAND logic gate 48. When the NAND logic gate 48 has a high logic voltage at the first input terminal from the supervisory controller 26 and a high logic voltage at the second input terminal from the gate 46 the gate 48 outputs a low logic voltage that turns off the transistor 123. When the transistor 123 is turned off, a supply voltage is removed from the load 12.

During desired operation of controller 24, the controller 24 generates a second output signal having a predetermined characteristic that is received by the signal detection circuit 42. In one embodiment, the controller 24 generates a PWM signal having a predetermined frequency that is received by the signal detection circuit 42. When the transistor 114 receives the second output signal via the capacitor 110, the transistor 114 discharges the capacitor 112 below a threshold voltage level such that the node 120 has a low logic voltage. When the node 120 has a low logic voltage, the transistor 116 is turned off and the node 99 has a low logic voltage. When the first and second input terminals of the NAND logic gate 44, coupled to the node 99, have a low logic voltage, the NAND logic gate 44 outputs a high logic voltage that is received at a first input terminal of the NAND logic gate 46. When the first input terminal of the NAND logic gate 46 has a high logic voltage and a second input terminal of the gate 46 has a high logic voltage, the gate 46 outputs a low logic voltage that is received at the second input terminal of the NAND logic gate 48. When the NAND logic gate 48 has a high logic voltage at the first input terminal from the supervisory controller 26 and a low logic voltage at the second input terminal, the gate 48 outputs a high logic voltage that allows transistor 123 to turn on when ignition switch 151 is closed. When the transistor 123 is turned on, a supply voltage is supplied to the load 12.

During an operational error condition of the controller 24, the transistor 114 does not receive the second output signal having the predetermined characteristic from the controller 24. As a result, the transistor 114 allows the capacitor 112 to be charged greater than or equal to a threshold voltage such that the node 120 has a high logic voltage. When the node 120 has a high logic voltage, the transistor 116 is turned on and the node 99 has a high logic voltage. When first and second input terminals of the NAND logic gate 44 have a high logic voltage, the NAND logic gate 44 outputs a low logic voltage that is received at a first input terminal of the NAND gate 46. When the first input terminal of the NAND logic gate 46 has a low logic voltage and a second input terminal of the gate 46 has a high logic voltage, the gate 46 outputs a high logic voltage that is received at the second input terminal of the NAND gate 48. When the NAND logic gate 48 has a high logic voltage at the first input terminal from the supervisory controller 26 and a high logic voltage at the second input terminal from the gate 46, the gate 48 outputs a low logic voltage that turns off the transistor 123. When the transistor 123 is turned off, a supply voltage is removed from the load 12.

The energization circuit 28 is provided to supply a voltage to the load 12. The energization circuit 28 includes a battery 121, transistors 122, 123, 124, a logic supply 125, capacitors 126, 127, 128, 129, 130, resistors 140, 141, 161, 162, a zener diode 142, an inductor 150, and an ignition switch 151.

The transistor 122 provides reverse battery protection for the controllers. The transistor 122 includes a drain (D), a gate (G), and a source (S). The source (S) of the transistor 122 is electrically coupled to a node 152. The drain (D) of the transistor 122 is electrically coupled to a node 154. The gate (G) of the transistor 122 is electrically coupled to a node 156. Further, the battery 121 is electrically coupled to the node 152. Further, the capacitor 126 is electrically coupled between the node 152 and electrical ground.

The logic supply 125 is provided to supply a voltage Vdd to the watchdog monitoring circuit 20. The logic supply 125 includes: (i) an enable pin, (ii) a Vin pin, (iii) a GND pin, and (iv) a Vout pin. The logic supply 125 receives a logic enable signal (LE) from the supervisory controller 26 at the enable pin. The Vin pin is electrically coupled to the node 154. The capacitor 128 is electrically coupled between the pin Vin and electrical ground. The GND pin is electrically coupled to electrical ground. The Vout pin is electrically coupled to a node 158 that outputs the voltage Vdd. Further, the capacitor 129 is electrically coupled between the node 158 and electrical ground. Further, the capacitor 127, the resistor 140, and the zener diode 142 are electrically coupled in parallel between the nodes 154, 156.

The transistor 124 is provided to supply a voltage to the load 12, and to remove the voltage from the load 12 during a power down condition. The transistor 124 includes a drain (D), a gate (G), and a source (S). The drain (D) of the transistor 124 is electrically coupled to the node 154. The gate (G) of the transistor 124 is electrically coupled to the node 156. The source (S) of the transistor 124 is electrically coupled to a first end of the inductor 150. A second end of the inductor 150 is electrically coupled to a node 160.

The transistor 123 is provided for controlling transistors 122, 124. The transistor 123 includes a drain (D), a gate (G), and a source (S). The drain (D) of the transistor 123 is electrically coupled to a resistor 141 that is further electrically coupled to the node 156. The gate (G) of the transistor 123 is electrically coupled to the node 165. The source (S) of the transistor 124 is electrically coupled to electrical ground.

The ignition switch 151 is provided to indicate when a user desires the system 10 to be operational. The ignition switch 151 is electrically coupled to a node 159. A resistor 161 is electrically coupled between the node 159 and electrical ground. A resistor 162 is electrically coupled between the node 159 and the node 165. When the ignition switch 151 has a closed operational position, a voltage is supplied via the resistor 162 to the node 165. Alternately, when the ignition switch 151 has an open operational position, a voltage is not supplied to the node 165.

A brief explanation of the operation of the energization circuit 28 will now be provided. When the ignition switch 151 is moved to a closed operational position, a high logic voltage is applied to the node 165 operably coupled to the gate (G) of the transistor 123, if a high logic voltage is applied to the node 49 by the NAND logic gate 48 indicating desired operation of the controllers 22, 24. In response to the high logic voltage being applied to the gate (G) of the transistor 123, the transistor 123 turns on which induces the transistors 122, 124 to turn on. When the transistors 122, 124 are turned on, a battery voltage is supply to the load 12. Alternately, when ignition switch 151 is moved to the closed operational position and the NAND logic gate 48 applies a low logic voltage to the node 49 indicating an operational error condition in at least one of the controllers 22, 24, the transistor 123 is turned off, which causes the transistors 122, 124 to turn off. When the transistors 122, 124 are turned off, the battery voltage is removed from the load 12.

Further, when the ignition switch 151 is moved to an open operational position, a low logic voltage is applied to the node 165 operably coupled to the gate (G) of the transistor 123, which turns off the transistor 123. In response, the transistors 122, 124 are turned off which removes a battery voltage being applied to the load 12.

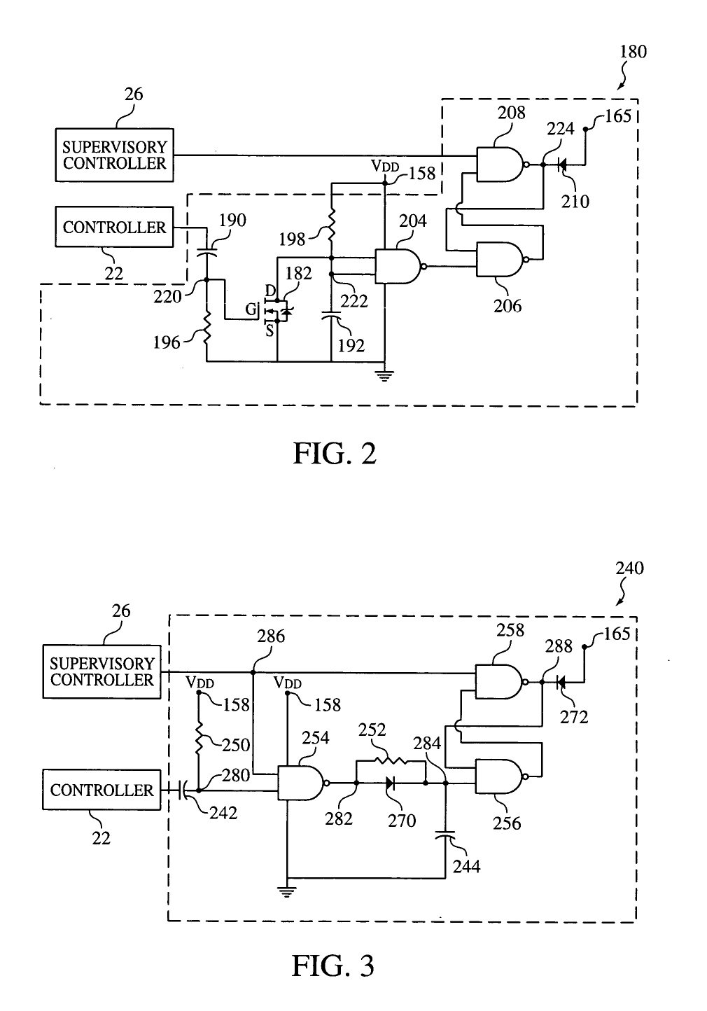

Referring to FIG. 2, a watchdog monitoring circuit 180 that can be utilized instead of the watchdog monitoring circuit 20 for monitoring operation of the controller 22 is illustrated. The watchdog monitoring circuit 180 includes a transistor 182, capacitors 190, 192, resistors 196, 198, NAND logic gates 204, 206, 208, and a diode 210.

The transistor 182 is provided for sensing an output voltage generated by the controller 22. The transistor 182 and includes a gate (G), a drain (D), and a source (S). The gate (G) of the transistor 182 is electrically coupled to the node 220. The source (S) of the transistor 182 is electrically coupled to electrical ground. The capacitor 190 is electrically coupled between the controller 22 and a node 220. A resistor 196 is electrically coupled between the node 220 and electrical ground. The drain (D) of the transistor 182 is electrically coupled to first and second input terminals of the NAND logic gate 204 at node 222.

The NAND logic gate 204 is provided for sensing when an output voltage at the node 222 has either a high logic voltage indicating an operational error condition associated with the controller 22, or a low logic voltage indicating a normal operational condition associated with the controller 22. The NAND logic gate 204 includes a first and second input terminals and an output terminal. The first and second input terminals of the NAND logic gate 204 is electrically coupled to the node 222. A capacitor 192 is electrically coupled between the node 222 and electrical ground. A resistor 198 is electrically coupled between the node 222 and the node 158.

The NAND logic gate 206 includes first and second input terminals and an output terminal. The first input terminal of the NAND logic gate 206 is electrically coupled to the output terminal of the NAND logic gate 204. The second input terminal of the NAND logic gate 206 is electrically coupled to a node 224.

The NAND logic gate 208 includes first and second input terminals and an output terminal. A first input terminal of the NAND logic gate 208 is electrically coupled to the supervisory controller 26. The second input terminal of the NAND logic gate 208 is electrically coupled to the output terminal of the NAND logic gate 206. The output terminal of the NAND logic gate 208 is electrically coupled to the node 224. A diode 210 is electrically coupled between the node 224 and a node 165.

During desired operation of controller 22, the controller 22 generates a first output signal having a predetermined characteristic that is received by the monitoring circuit 180. In one embodiment, the controller 22 generates a PWM signal having a predetermined frequency that is received by the monitoring circuit 180. When the transistor 182 receives the first output signal via the capacitor 190, the transistor 182 discharges the capacitor 192 below a threshold voltage level such that the node 222 has a low logic voltage. When the node 222 has a low logic voltage, the NAND logic gate 204 outputs a high logic voltage that is received by the first input terminal of the NAND logic gate 206. When first and second input terminals of the NAND logic gate 206 have high logic voltages, the NAND logic gate 206 outputs a low logic voltage that is received by the second input terminal of the NAND logic gate 208. When the first input terminal of the NAND logic gate 208 has a high logic voltage from the supervisory controller 26 and the second input terminal of the NAND logic gate 208 has a low logic voltage from the gate 206, the NAND logic gate 208 outputs a high logic voltage. As result, the node 165 has a high logic voltage that allows the transistor 123 of the energization circuit 28 to turn on when ignition switch 151 is closed. Further, the transistors 122 and 124 are turned on and supply a battery voltage to the load 12.

During an operational error condition of the controller 22, the transistor 182 does not receive the first output signal having the predetermined characteristic from the controller 22. As a result, the transistor 182 allows the capacitor 192 to be charged greater than or equal to a threshold voltage level such that the node 222 has a high logic voltage. When the node 222 has a high logic voltage, the NAND logic gate 204 outputs a low logic voltage that is received by the first input terminal of the NAND logic gate 206. When first terminal of the NAND logic gate 206 has a low logic voltage and the second terminal of the NAND logic gate 206 has a high logic voltage, the NAND logic gate 206 outputs a high logic voltage that is received by the second input terminal of the NAND logic gate 208. When the first and second input terminals of the NAND logic gate 208 have high logic voltages, the NAND logic gate 208 outputs a low logic voltage. As result, the node 165 has a low logic voltage that turns off the transistor 123 of the energization circuit 28. Further, the transistors 122 and 124 are turned off and a battery voltage is removed from the load 12.

Referring to FIG. 3, a watchdog monitoring circuit 240 that can be utilized instead of the watchdog monitoring circuit 20 for monitoring operation of the controller 22 is illustrated. The watchdog monitoring circuit 240 includes capacitors 242, 244, resistors 250, 252, NAND logic gates 254, 256, 258, and diodes 270, 272.

The NAND logic gate 254 is provided for sensing an output voltage generated by the controller 22. The NAND logic gate 254 includes first and second input terminals and an output terminal. The first input terminal of the NAND logic gate is electrically coupled to a node 280. A capacitor 242 is electrically a coupled between the node 280 and the controller 22. A resistor 250 is electrically coupled between the node 280 and the node 158. The second input terminal of the NAND logic gate 254 is electrically coupled to a node 286 that is further electrically coupled to the supervisory controller 26. The output terminal of the NAND logic gate 254 is electrically coupled to a node 282.

The NAND logic gate 256 includes first and second input terminals and an output terminal. The first input terminal of the NAND logic gate 256 is electrically coupled to a node 284. A capacitor 244 is electrically coupled between the node 284 and electrical ground. A parallel combination of a resistor 252 and a diode 270 is electrically coupled between the node 284 and a node 282. The second input terminal of the NAND logic gate 256 is electrically connected to the node 288.

The NAND logic gate 258 includes first and second input terminals and an output terminal. The first input terminal of the NAND logic gate 258 is electrically coupled to the supervisory controller 26. The second input terminal of the NAND logic gate 258 is electrically coupled to the output terminal of the NAND logic gate 256. The output terminal of the NAND logic gate 258 is electrically a coupled to the node 288. A diode 272 is electrically coupled between the node 288 and the node 165.

During desired operation of controller 22, the controller 22 generates a first output signal having a predetermined characteristic that is received by the watchdog monitoring circuit 240. In one embodiment, the controller 22 generates a PWM signal having a predetermined frequency that is received by the watchdog monitoring circuit 240. When the first input terminal of the NAND gate 254 receives a low logic voltage from the capacitor 242 when the capacitor 242 is discharged below a threshold voltage level, and the second input terminal of the gate 254 receives a high logic voltage from the supervisory controller 26, the gate 254 outputs a high logic voltage and the capacitor 244 is quickly charged through the diode 270. When first and second input terminals of the NAND logic gate 256 have high logic voltages, the NAND logic gate 256 outputs a low logic voltage that is received by the second input terminal of the NAND logic gate 258. When the first input terminal of the NAND logic gate 258 has a high logic voltage from the supervisory controller 26 and the second input terminal of the NAND logic gate 258 has a low logic voltage, the NAND logic gate 258 outputs a high logic voltage. As result, the node 165 has a high logic voltage that allows the transistor 123 of the energization circuit 28 to turn on when ignition switch is closed. Further, the transistors 122 and 124 are turned on and supply a battery voltage to the load 12.

During an operational error condition of the controller 22, the NAND logic gate 254 does not receive the first output signal having the predetermined characteristic from the controller 22. As a result, the capacitor 242 is charged greater than or equal to a threshold voltage such that the node 280 and the first input terminal of the NAND logic gate 254 has a high logic voltage. Further, when the second input terminal of the NAND logic gate has a high logic voltage from the supervisory controller 26 the NAND logic gate 254 outputs a low logic voltage that allows the capacitor 244 to be discharged through the resistor 252. When a sufficient amount of time has elapsed for the capacitor 244 to be discharged below the threshold of the NAND logic gate 256, a low logic voltage is received by the first input terminal of the NAND logic gate 256. When first terminal of the NAND logic gate 256 has a low logic voltage and the second terminal of the NAND logic gate 256 has a high logic voltage, the NAND logic gate 256 outputs a high logic voltage that is received by the second input terminal of the NAND logic gate 258. When the first and second input terminals of the NAND logic gate 258 have high logic voltages, the NAND logic gate 258 outputs a low logic voltage. As result, the node 165 has a low logic voltage that turns off the transistor 123 of the energization circuit 28. Further, the transistors 122 and 124 are turned off and a battery voltage is removed from the load 12.

The watchdog monitoring circuit 240 is configured to allow the capacitor 25 244 to be quickly charged by the NAND logic gate 254 whenever the supervisory controller 26 outputs a low logic voltage at the node 286. Thus, the circuit 240 can be reset by a low logic voltage from the supervisory circuit 26 without having to turn off the logic supply 125.

The watchdog monitoring circuit and a method for controlling energization of the load utilizing the watchdog monitoring circuit provide a substantial advantage over other systems and methods. In particular, the watchdog monitoring circuit provides a technical effect of monitoring a plurality of output signals from a plurality of controllers for determining whether the controllers are operating as desired.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the present application.

What is claimed is:

1. A watchdog monitoring circuit, comprising:
a first signal detection circuit configured to determine a first error condition associated with a first device when the first signal detection circuit does not receive a first plurality of signal pulses having a first predetermined characteristic from the first device;
a second signal detection circuit configured to determine a second error condition associated with a second device when the second signal detection circuit does not receive a second plurality of signal pulses having a second predetermined characteristic from the second device; and
a first electrical control circuit operably associated with the first and second signal detection circuits, the first electrical control circuit configured to remove power from a load when either the first signal detection circuit determines the first error condition or the second signal detection circuit determines the second error condition.

2. The watchdog monitoring circuit of claim 1, wherein the first electrical control circuit is further configured to supply power to the load when the first signal detection circuit has not determined the first error condition and the second signal detection circuit has not determined the second error condition.

3. The watchdog monitoring circuit of claim 1, wherein the first electrical control circuit is further configured to re-supply power to the load upon receipt of a reset signal or an ignition switch signal.

4. The watchdog monitoring circuit of claim 1, wherein power continues to be supplied to the first electrical control circuit, when the first electrical control circuit removes power from the load.

5. The watchdog monitoring circuit of claim 1, wherein the first signal detection circuit comprises a first capacitor electrically coupled to a first transistor, the first capacitor configured to be charged greater than or equal to a first threshold voltage level indicating the first error condition, when the first transistor does not receive the first plurality of signal pulses having the first predetermined characteristic.

6. The watchdog monitoring circuit of claim 5, wherein the first transistor is configured to discharge the first capacitor below the first threshold voltage level when the first transistor receives the first plurality of signal pulses having the first predetermined characteristic from the first device.

7. The watchdog monitoring circuit of claim 6, wherein the second signal detection circuit comprises a second capacitor electrically coupled to a second transistor, the second capacitor configured to be charged greater than or equal to a second threshold voltage level indicating the second error condition, when the second transistor does not receive the second plurality of signal pulses having the second predetermined characteristic.

8. The watchdog monitoring circuit of claim 7, wherein the second transistor is configured to discharge the second capacitor below the second threshold voltage level when the second transistor receives the second plurality of signal pulses having the second predetermined characteristic from the second device.

9. The watchdog monitoring circuit of claim 1, wherein the first predetermined characteristic comprises at least one of a first predetermined frequency and a first predetermined amplitude.

10. The watchdog monitoring circuit of claim 9, wherein the second predetermined characteristic comprises at least one of a second predetermined frequency and a second predetermined amplitude.

11. A method for controlling energization of a load utilizing a watchdog monitoring circuit electrically coupled to an electrical control circuit, the watchdog monitoring circuit having first and second signal detection circuits electrically coupled to the electrical control circuit, the electrical control circuit being electrically coupled to the load, the method comprising:
determining a first error condition associated with a first device when the first signal detection circuit does not receive a first plurality of signal pulses having a first predetermined characteristic from the first device, indicating a first error condition associated with the first device;
determining a second error condition associated with a second device when the second signal detection circuit does not receive a second plurality of signal pulses having a second predetermined characteristic from the second device, indicating a second error condition associated with the second device; and
removing power from the load when at least one of the first and second error conditions are determined, utilizing the electrical control circuit.

12. The method of claim 11, further comprising supplying power to the load when the first and second error conditions have not been determined.

13. The method of claim 11, further comprising re-supplying power to the load upon receipt of a reset signal or an ignition switch signal.

14. The method of claim 11, further comprising continuing to supply power to the first electrical control circuit while power is removed from the load.

15. The method of claim 11, wherein the first predetermined characteristic comprises at least one of a first predetermined frequency and a first predetermined amplitude.

16. The method of claim 15, wherein the second predetermined characteristic comprises at least one of a second predetermined frequency and a second predetermined amplitude.
